(19) United States
(12) Patent Application Publication
(10) Pub. No.: US 2024/0318446 A1
(43) Pub. Date: Sep. 26, 2024

(54) MODULAR SHED DESIGN AND METHOD FOR CONSTRUCTING THE SHED

(71) Applicants: Farid ISMAYILOV, Bernardsville, NJ (US); Darius TORABY, Cos Cob, CT (US)

(72) Inventors: Farid ISMAYILOV, Bernardsville, NJ (US); Darius TORABY, Cos Cob, CT (US)

(21) Appl. No.: 18/610,351

(22) Filed: Mar. 20, 2024

Related U.S. Application Data
(60) Provisional application No. 63/453,451, filed on Mar. 20, 2023.

(51) Int. Cl. E04H 1/12; E04G 7/28; F21V 23/00; F21V 33/00

(52) U.S. Cl. CPC E04H 1/1205; E04G 7/28; F21V 33/006; F21V 23/001

(57) ABSTRACT

There is a shed and/or scaffolding which is configured to be made from any suitable material such as steel, fiber reinforced decking panels or a parapet. These panels can be made with integrated lights such as LED lights and then held together via steel guides or I-beams. There is also a method for constructing the scaffolding or shed design as well.

### CROSS REFERENCE TO RELATED APPLICATIONS

This application is a non-provisional application of and claims priority to U.S. Provisional application Ser. No. 63/453,451 filed on Mar. 20, 2023 the disclosure of which is hereby incorporated herein by reference in its entirety.

### BACKGROUND OF THE INVENTION

One embodiment relates to a modular shed design and method which is configured to be made from fiber reinforced decking panels. These panels can be made with integrated lights such as LED lights and then held together via steel guides or I-beams.

### SUMMARY

One embodiment relates to scaffolding which is configured to be made from fiber reinforced decking panels or a parapet. These panels can be made with integrated lights such as LED lights and then held together via steel guides or I-beams. For example, in at least one embodiment there is a modular shed design comprising at least one frame and at least one panel coupled to the frame. There is at least one connector coupled to the frame, with the connector for coupling the panel to the frame. There is at least one light being disposed in the one panel and at least one electrical conduit disposed in the frame, the electrical conduit configured to provide power to the light.

There is also a process for assembling a modular shed comprising the steps of spacing at least two frames apart from each other, coupling the frames together via at least one beam. Next, the process includes connecting at least one connector to at least one beam. Next, the process includes connecting at least one panel to the frame. Next, the process includes connecting at least one light to the panel such that said at least line light is disposed in said panel. Next, the process includes illuminating the light inside of the panel.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A is an end view of a first panel;

FIG. 1B is a side view of the panel;

FIG. 1C is a front side view of the panel;

FIG. 2A is a first part of a panel;

FIG. 2B is a second part of a panel;

FIG. 2C is a side view of the panels put together;

FIG. 2D is a close up view of the panels together;

FIG. 3A is a view of a side beam;

FIG. 3B is an end view of the side beam;

FIG. 3C is a front view of the beam;

FIG. 3D is a top view of a beam;

FIG. 3E is a view of another beam;

FIG. 3F is a side view of the beam of FIG. 3E;

FIG. 4 is a perspective view of the beams put together;

FIG. 5 is another perspective view of the beams put together;

FIG. 6 is a perspective view of another set of beams put together;

FIG. 7A is a side view of a frame;

FIG. 7B is a front view of a frame;

FIG. 8 is a perspective view of a frame;

FIG. 9A is a side view of a bracket;

FIG. 9B is an end view of a bracket;

FIG. 10A is a side view of a frame;

FIG. 10B is a portion of the frame;

FIG. 10C is an end view of the frame;

FIG. 11 is a perspective view of the frame;

FIG. 12A is a side view of a cross bracing;

FIG. 12B is a side view of a coupling;

FIG. 12C is a side view of a coupling;

FIG. 12D is an end view of a coupling;

FIG. 12E is an end view of an open coupling;

FIG. 13A is a perspective view of a frame;

FIG. 13B is a perspective view of the additional portion of the frame; and

FIG. 14 is a perspective view of a coupling.

FIG. 15A is a view of another panel;

FIG. 15B is a side view of the panel;

FIG. 16 is a view of another panel;

FIG. 17 is a view of a plurality of panels which are configured to be fit together;

FIG. 18A is a view of another panel;

FIG. 18B is a side view of the panel;

FIG. 19 is a view of a plank;

FIG. 20 is a view of a plank which is braced together;

FIG. 21 is a view of another panel;

FIG. 22 is a view of another panel;

FIG. 23 is a view of another panel;

FIG. 24A is a view of a frame;

FIG. 24B is a view of another frame;

FIG. 24C is a side view of the frame being assembled with lights;

FIG. 24D is the side view of the assembled frame of FIG. 24C;

FIG. 24E is an end view of the frame of FIG. 24C;

FIG. 24F is a side view of a frame;

FIG. 24G is another side view of a frame;

FIG. 25A is a view of a box;

FIG. 25B is a view of a box;

FIG. 25C is a top view of a box;

FIG. 26A is a view of a brace;

FIG. 26B is a view of a bracket;

FIG. 26C is a top view of a bracket;

FIG. 26D is a side view of the bracket;

FIG. 26E is a side view of a bracket;

FIG. 27A is a side view of a lock; and

FIG. 27B is a top view of a lock;

FIG. 28 is a view of a flow chart for assembling a sidewalk shed;

FIG. 29A is a view of a first step for assembling the sidewalk shed;

FIG. 29B is a view of a second step for assembling the sidewalk shed;

FIG. 30A is a view of a third step for assembling the sidewalk shed;

FIG. 30B is a view of a fourth step for assembling the sidewalk shed;

FIG. 31A is a view of a fifth step for assembling the sidewalk shed;

FIG. 31B is a view of a sixth step for assembling the sidewalk shed;

FIG. 32A is a view of a seventh step for assembling the sidewalk shed;

FIG. 32B is a view of an eight step for assembling the sidewalk shed;

FIG. 33A is a view of a ninth step for assembling the sidewalk shed;

FIG. 33B is a view of a tenth step for assembling the sidewalk shed;

FIG. 34A is a view of an eleventh step for assembling the sidewalk shed;

FIG. 34B is a view of a twelfth step for assembling the sidewalk shed;

FIG. 35A is a view of a thirteenth step for assembling a sidewalk shed;

FIG. 35B is a view of a fourteenth step for assembling a sidewalk shed;

FIG. 36A is a view if a fifteenth step for assembling a sidewalk shed;

FIG. 36B is a view of a sixteenth step for assembling a sidewalk shed;

FIG. 37A is a view of a seventeenth step for assembling a sidewalk shed;

FIG. 37B is a view of an eighteenth step for assembling a sidewalk shed; and

FIG. 38 is a view of a nineteenth step for assembling a sidewalk shed.

### DETAILED DESCRIPTION

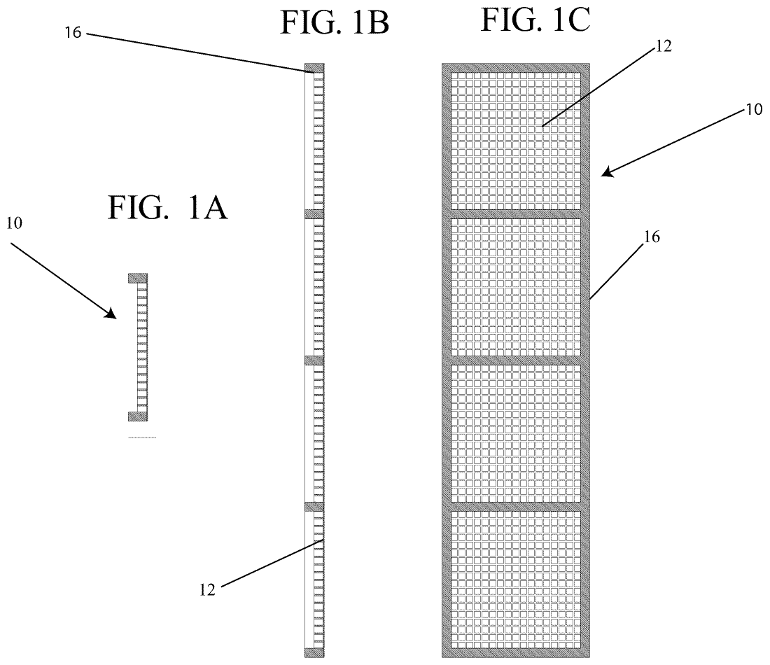

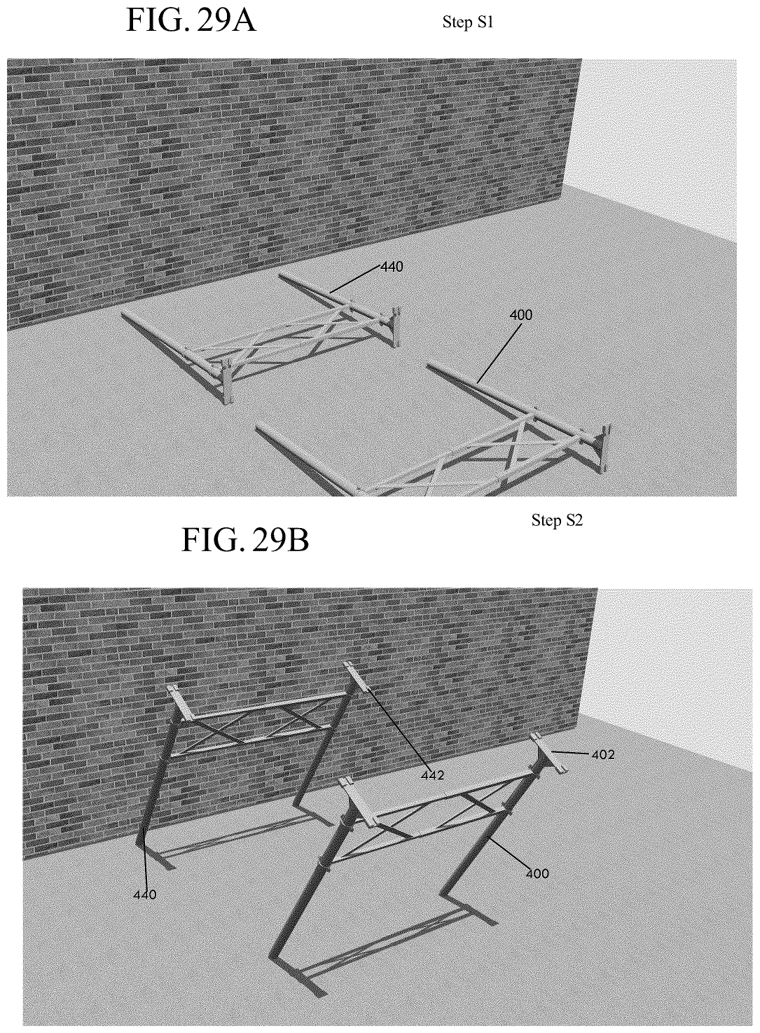

FIG. 1A is an end view of a first panel 10, this panel 10 has a frame 16 and a panel section 12 which is a checkerboard type section of a grate. FIG. 1B is a side view of the panel, and FIG. 1C is a front side view of the panel 10. These panels are configured to be placed on top of frames such as frames 400 and 440 shown in FIGS. 29A-38.

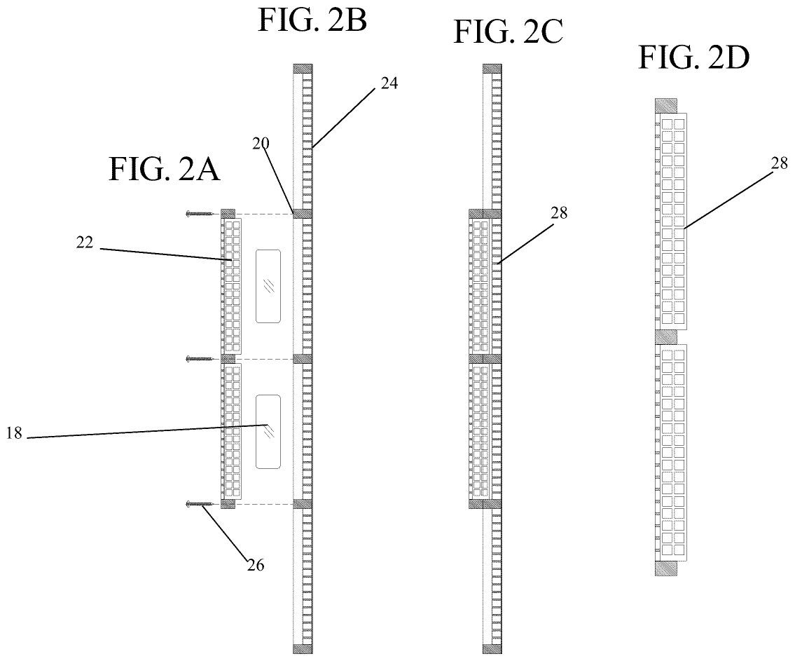

FIG. 2A is a first part of a panel 22 which is bolted to another panel 24 in FIG. 2B which secures lights 18. FIG. 2C shows this combined panel 28 which has first panel 22 securing lights 18 inside of second panel 24, wherein these lights are enclosed by side walls 20. At least one fastener 26 is configured to secure first panel 22 to second panel 24 thereby encasing the light 18 inside of these panels. (See FIG. 2D)

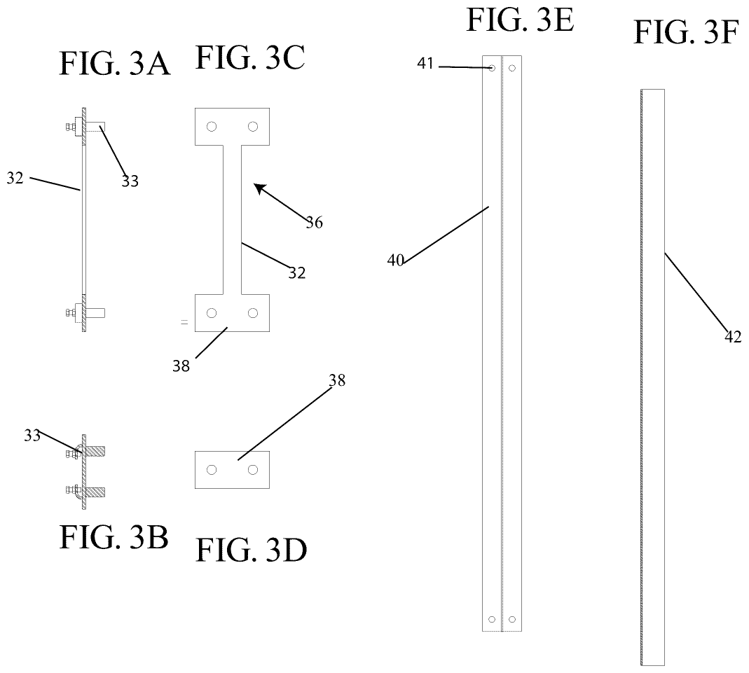

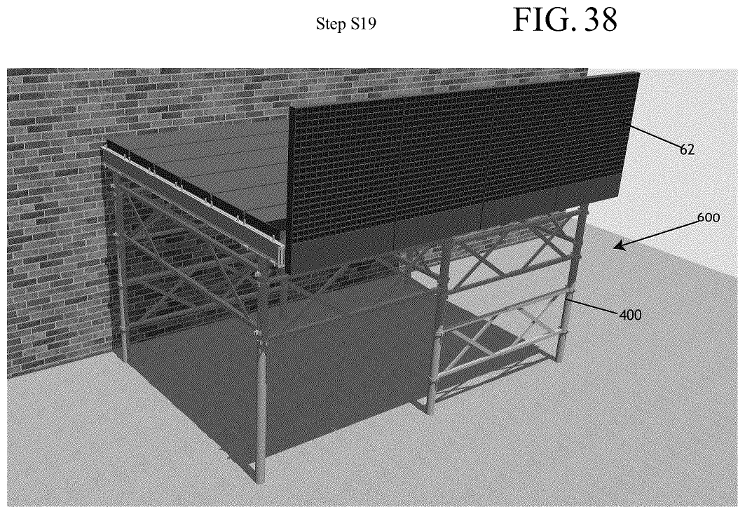

FIG. 3A is a view of a side beam such as an H-beam or guide connector 32 having bolts 33. FIG. 3B is an end view of this H-beam 32 with bolts 33. FIG. 3C is a side view of beam 32 having end panels 38. FIG. 38 is a view of the panel 38.

FIG. 3E is a top view of the T-beam 40, showing screw holes 41, while FIG. 3F is a side view of the T beam having a body extension section or I-beam 42.

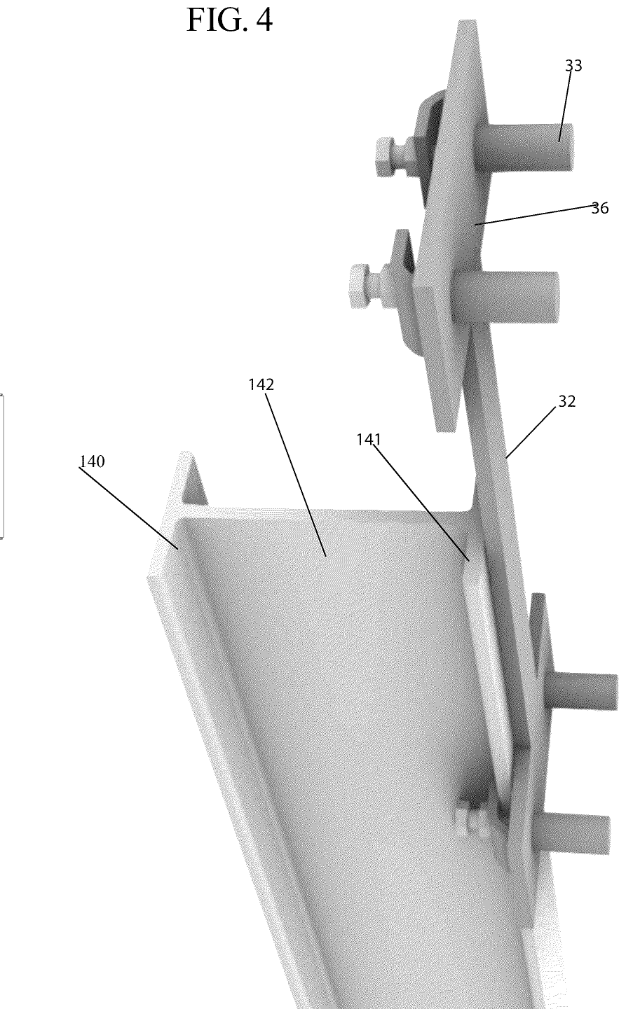

FIG. 4 is a perspective view of the beams put together wherein I beam 142 has an end section 140 and an opposite end section 141, coupled to H-beam 32. H-Beam 32 has bolts 33.

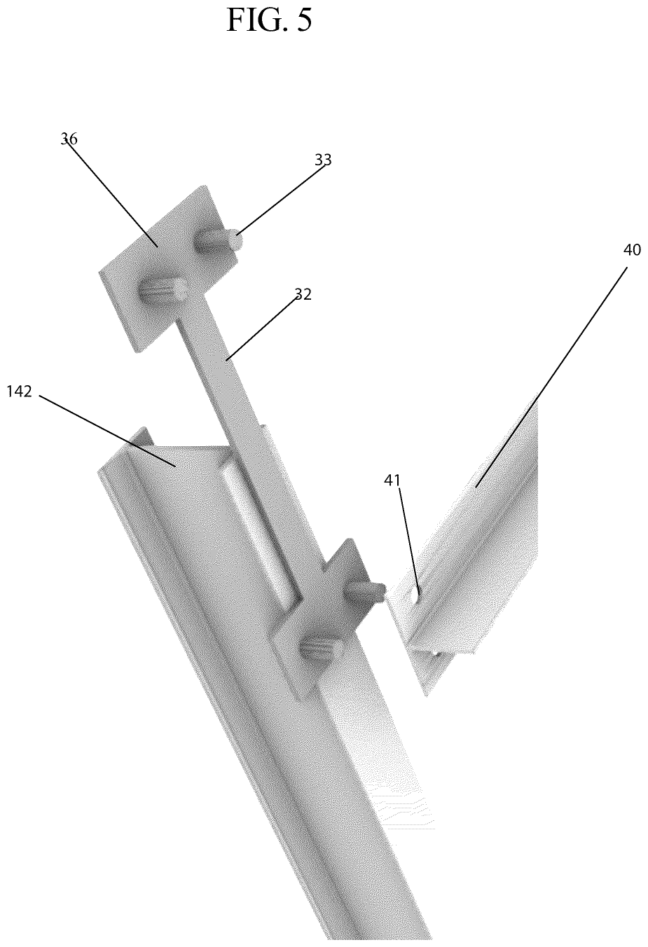

FIG. 5 is another perspective view of the beams put together wherein I beam 142 is coupled to H-beam 32 having end plate 36 and bolts 33. These H-beams are used to couple different I beams together such as I-beam 42, and also couple I-beams such as I-beam 42 to a T-shaped beam 40 with bolts 33 extending through screw holes 41 on T-shaped beam 40.

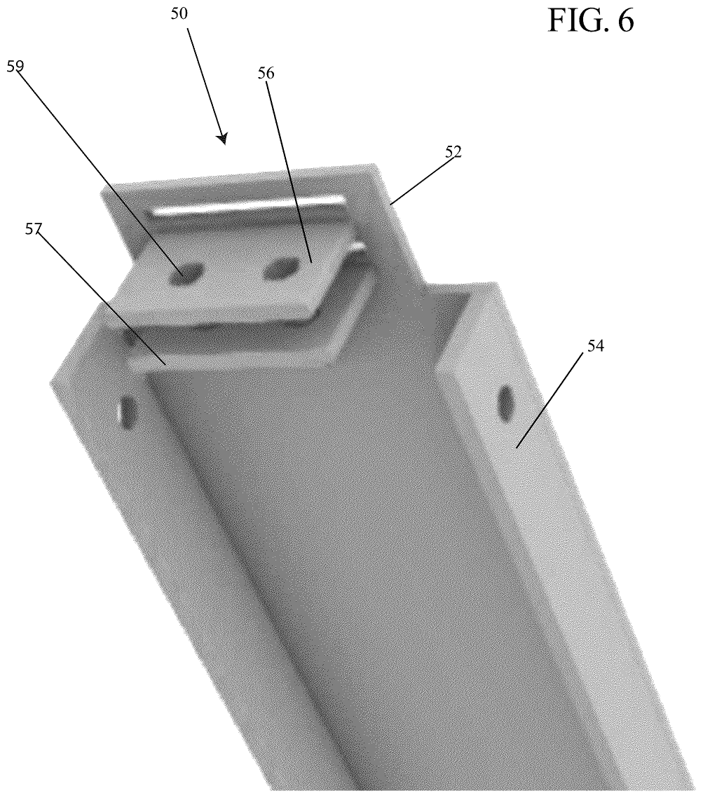

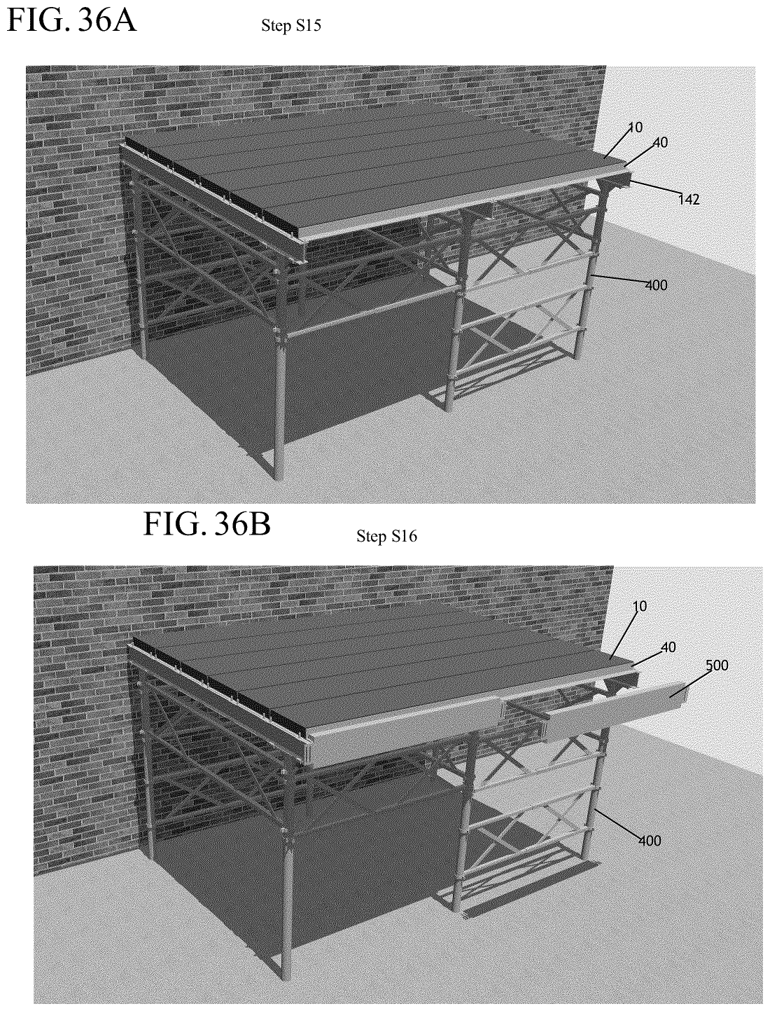

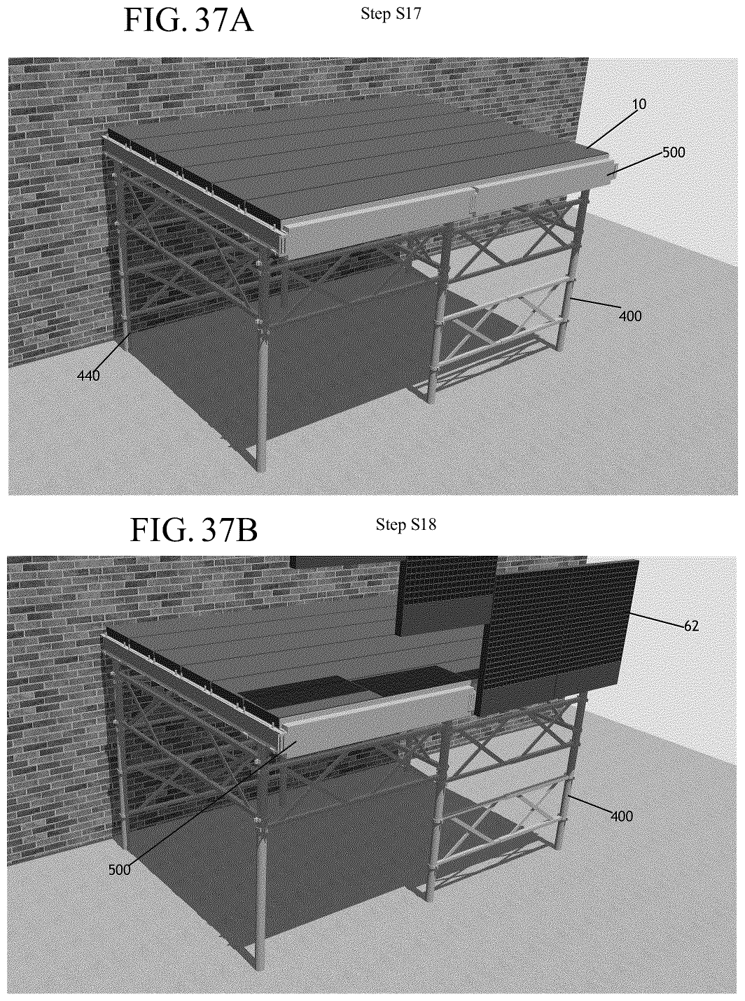

FIG. 6 is a perspective view of another set of beams put together wherein beam 50 includes end section 52, plate 56, and side guides 54. These beams 50 can be used to form front plates 500 shown in FIG. 36B. In this case, beam 50 is configured to be coupled to an I-beam such as I-beam 142. In this case, plate 56 which extends substantially perpendicular to the longitudinal extension of beam 50 has a corresponding parallel spaced plate 57. These two plates 56 and 57 are configured to fit around the end of an I-beam such as I-beam 142 shown in FIG. 5 thereby providing an end-cap to these I-beams. Beam 50 is secured to I-beam 142 via bolts extending through holes 59 on plates 56 and 57.

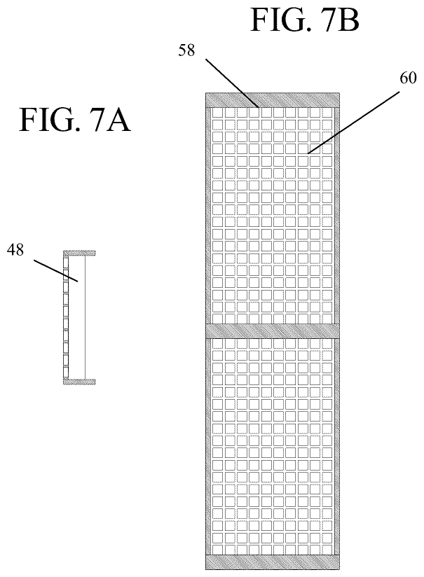

FIG. 7A is a side view of a frame 48, this frame as shown in FIG. 7B is a fiber reinforced frame which has an embedded light having an outer frame 58 and an inner section 60 having lights.

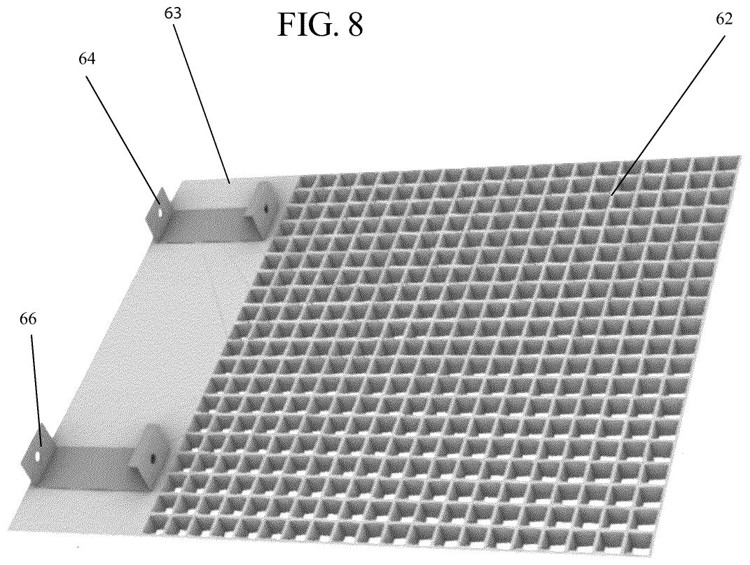

FIG. 8 is a view of a frame or panel 62 having a checkerboard frame of fiber reinforced decking or parapet having steel attachment brackets 64 and 66 on a frame section 63. Brackets 64 and 66 are configured to be coupled to beam 50 and/or front plates 500.

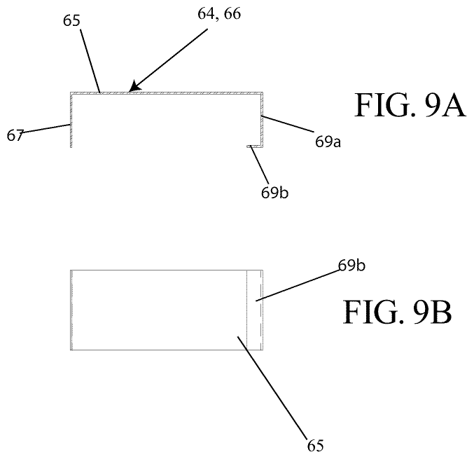

FIG. 9A is a side view of a steel brackets 64 and 66 having a base section 65, with arms 67 and 69a and 69b. Arm 69a extends substantially perpendicular to base section 65. Arm 69b extends substantially perpendicular to arm 69a. FIG. 9B is a top view of the bracket showing arm 69a as well as base section 65.

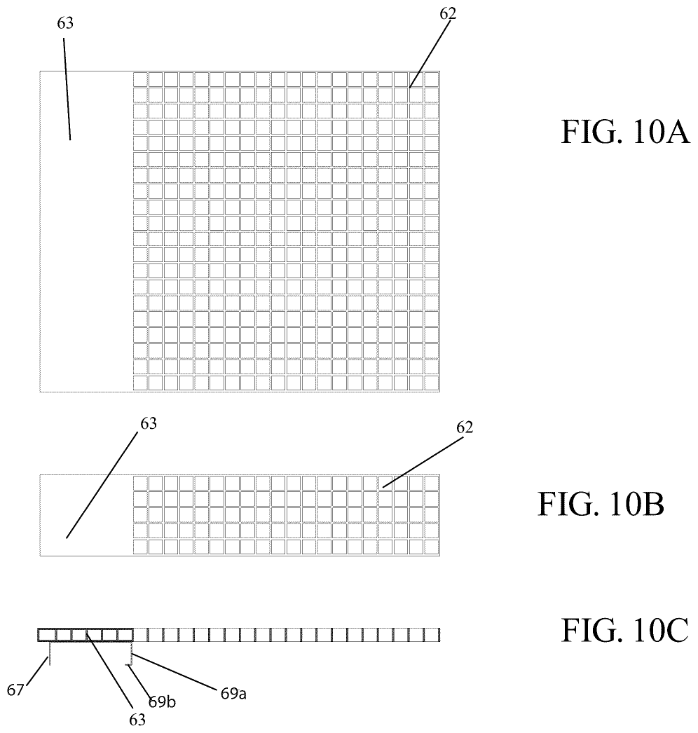

FIG. 10A is a side view of another fiber reinforced parapet or panel 62 having a frame section 63. FIG. 10B is a shortened section 62a having a steel section 63. FIG. 10C shows a side view of this section 63 having a fiber reinforced parapet with brackets 67, 69a and 69b.

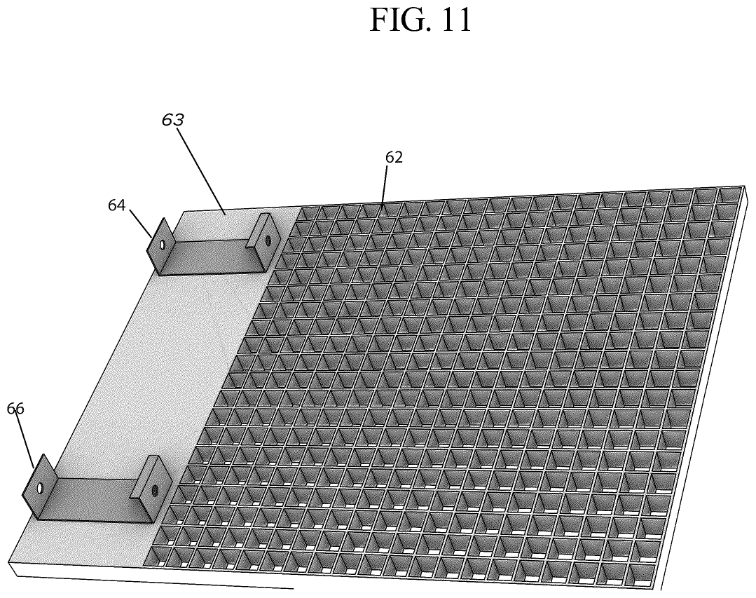

FIG. 11 is another view of the fiber reinforced parapet having the checkerboard section 62 a steel frame section 63 and brackets 64 and 66.

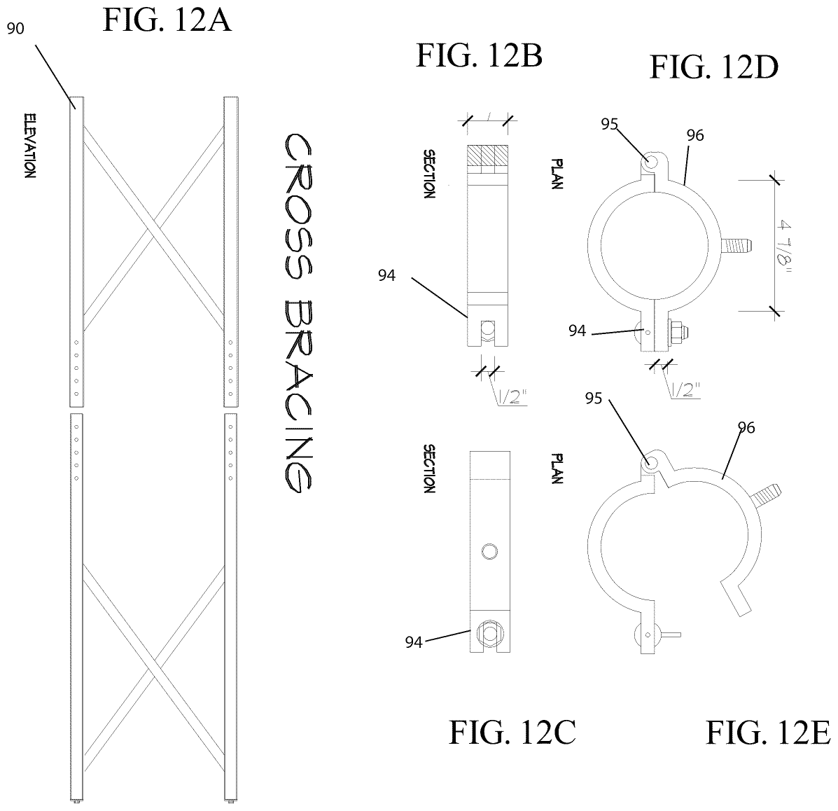

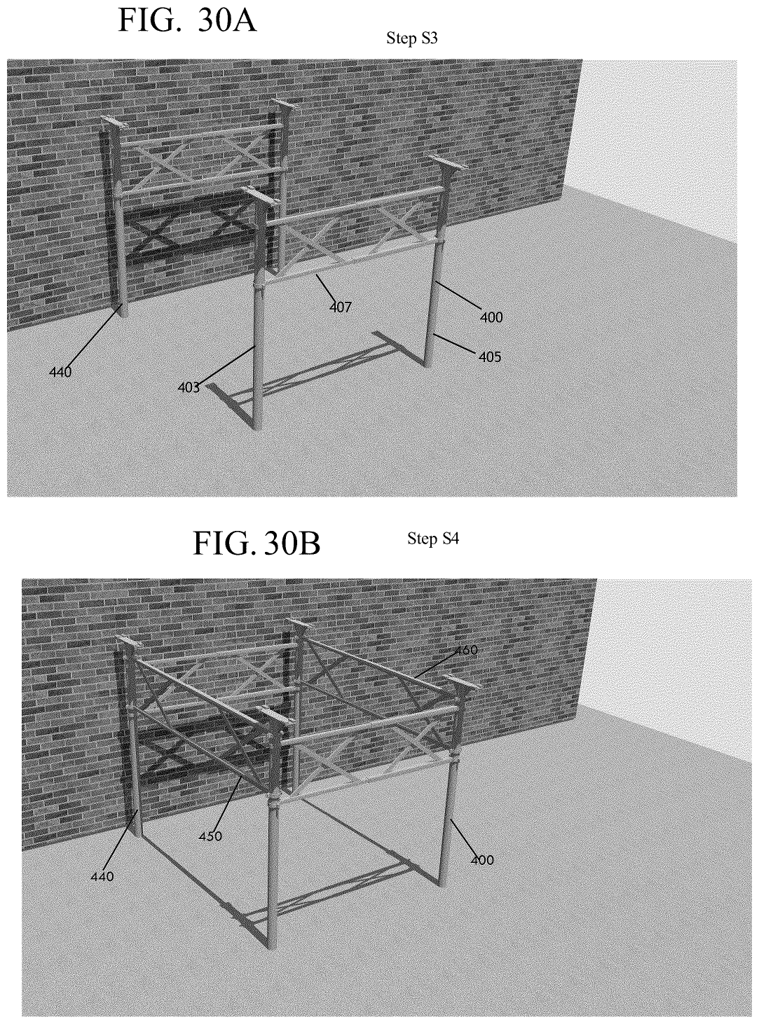

FIG. 12A is a side view of cross-bracing 90 which is similar or same as cross bracing 450 shown in FIG. 30B, while FIG. 12B is a side view of a coupling 96, FIG. 12C is a side view of the coupling 96, FIG. 12D is a side view of the coupling 96 with a round section and having a hinge section 95 as well as a lock section 94, and FIG. 12E is a side view of the coupling 96 in an open position.

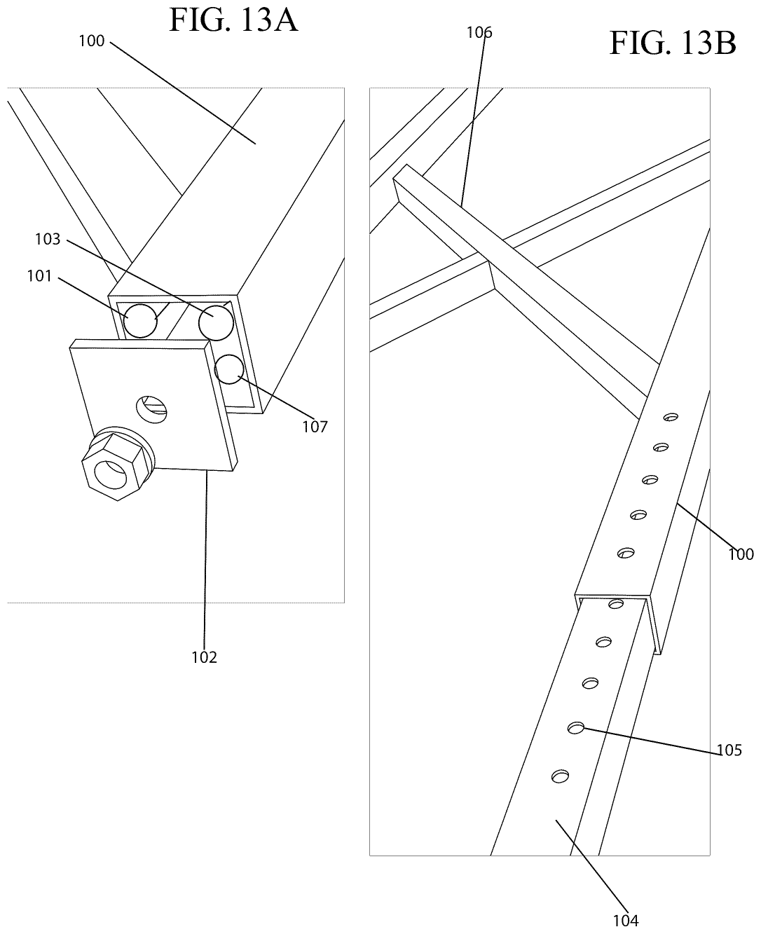

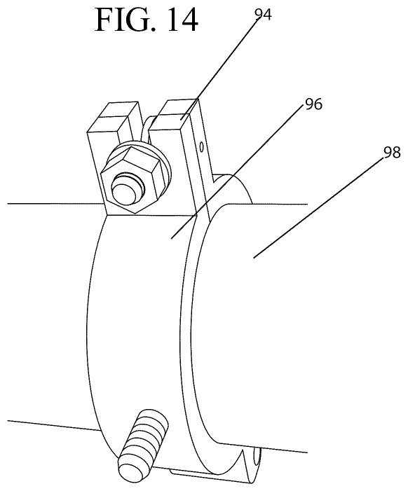

FIG. 13A is a perspective view of a frame 100 having an end piece 102. FIG. 13B is a perspective view of this frame wherein there are cross-braces 106 a base frame section 100 and a telescoping section 104 having holes 105. Inside of the frame section as shown in FIG. 13A are lines such as electrical lines 101 for providing electrical service to the lights as well as a plumbing line 103 for providing water to the shed as well, as a pneumatic or air line 107 which can be fed throughout the system. This allows for the site to have ready made power, pneumatic power or water to the site. This then allows for the connection of power tools, the use of pneumatic tools as well as water to be provided to the site.

FIG. 14 is a perspective view of a coupling 96 coupled over a piping section 98 and clamped by lock 94 which can be used to couple this entire framing system together.

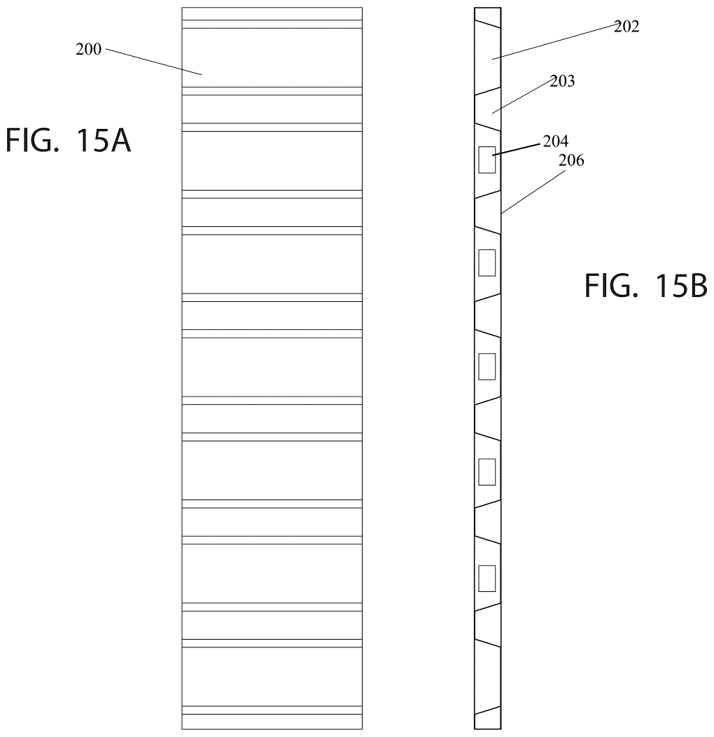

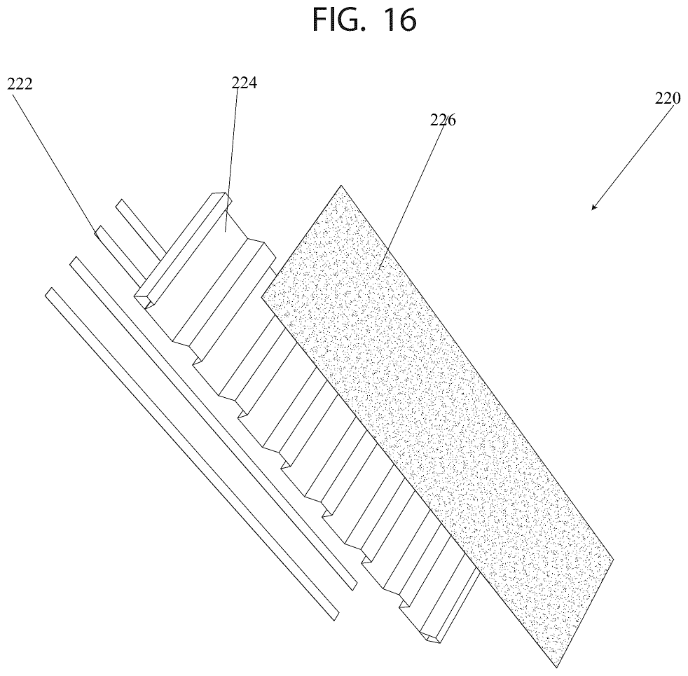

FIG. 15A is a view of another panel 200 which is a corrugated panel which is configured as a corrugated panel which as shown in FIG. 15B allows for certain indents 203, slots 204, as well as elevated sections 202, and other indents 206. Thus, with a corrugated frame, this design is a reinforced panel design which is sufficiently strong to receive parties walking on the panel. The slots 204 can be used to allow lines such as power lines 101, pneumatic lines 107 or water lines 103 to extend therethrough.

FIG. 16 is a view of another panel which shows a three layer panel which has a plurality of supports 222, a corrugated section 224, wherein this corrugated section has raised and lowered sections, as well as a top cover 226 which covers over the corrugated section.

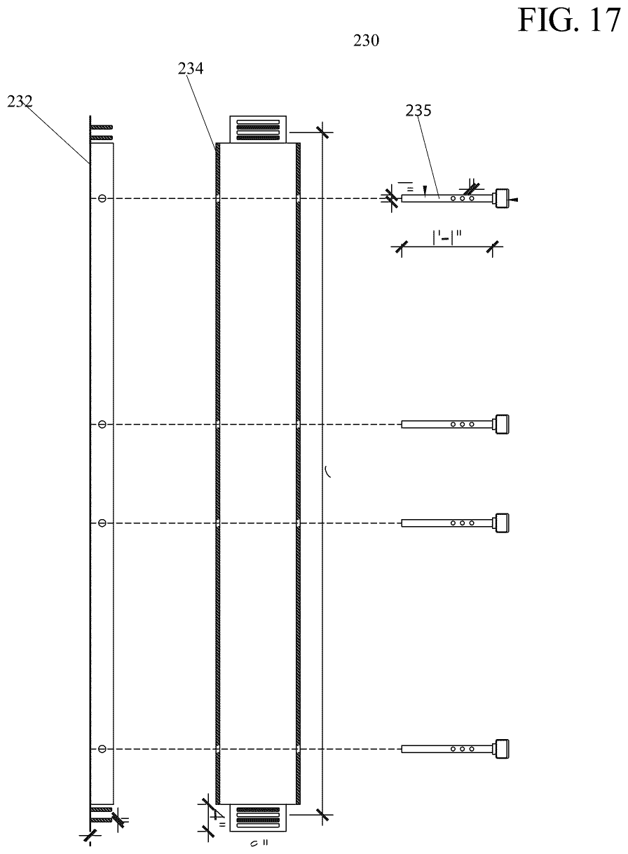

FIG. 17 is a view of a plurality of panels which are configured to be fit together. For example, there is a first panel 232, a second panel 234 and a plurality of fasteners 235 for fastening the panels together. These panels shown in FIG. 17 are similar to the panels or beam 50 shown in FIG. 6.

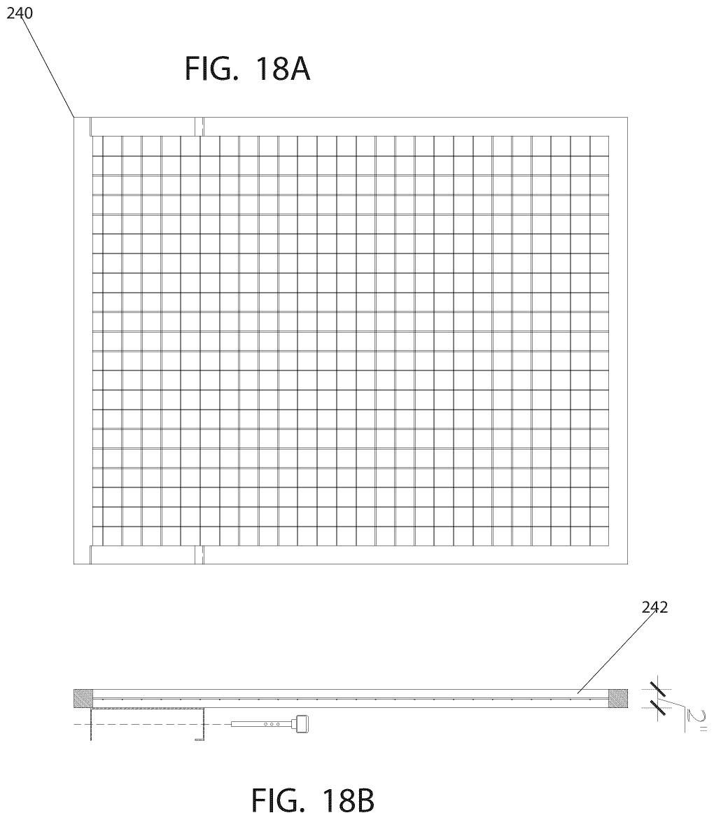

FIG. 18A is a view of another panel 240 which has a frame 242 and a fastener 243 as well shown in FIG. 18B.

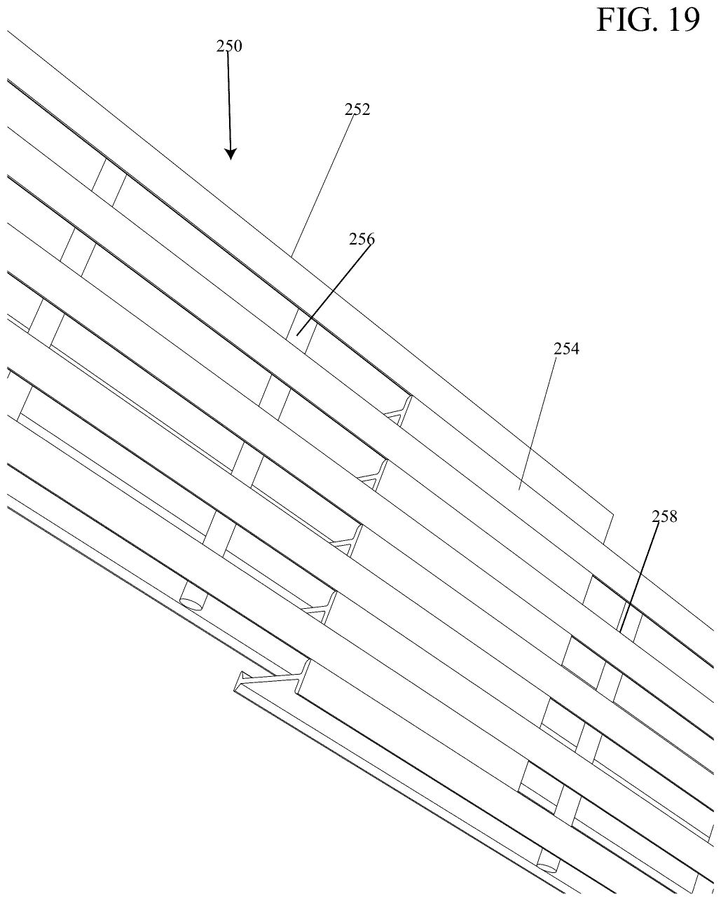

FIG. 19 is a view of a plank 250 which has a first set of beams 252 and a second set of beams 254. The first set of beams 252 and the second set of beams 254 are configured to mesh together and be held together with cross beams 256 and 258 which are configured to extend transverse to the longitudinal extension of these beams. These cross beams 256 are configured to lock the first set of beams 252 together.

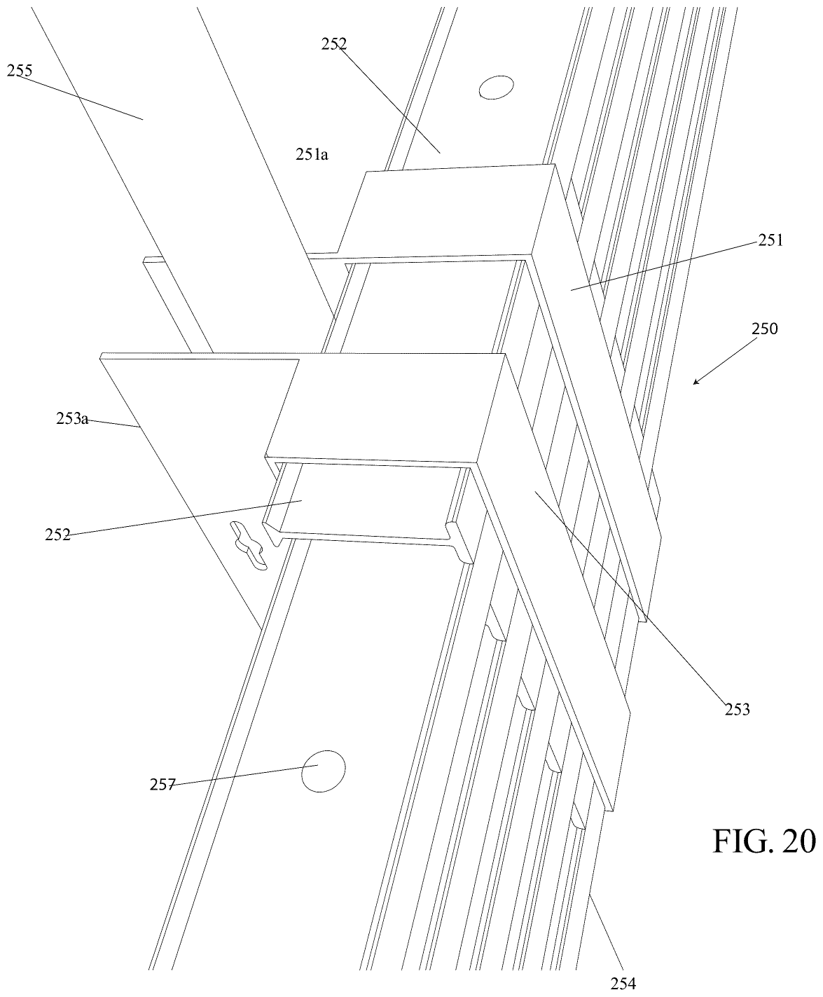

FIG. 20 is a view of a plank 250 which is braced together. With this view there is shown a plurality of beams 252 and 254 with cross brackets 251 and 253. There is a hole 257 as well as cross beams 255 which support this plank 250. There are side support brackets as well wherein these side support brackets 251a and 253a are used to couple the cross-beam 255 to the brackets. The beams 252 and 254 can be in the form of I-beams. Plank 250 can be used in place of panel 10.

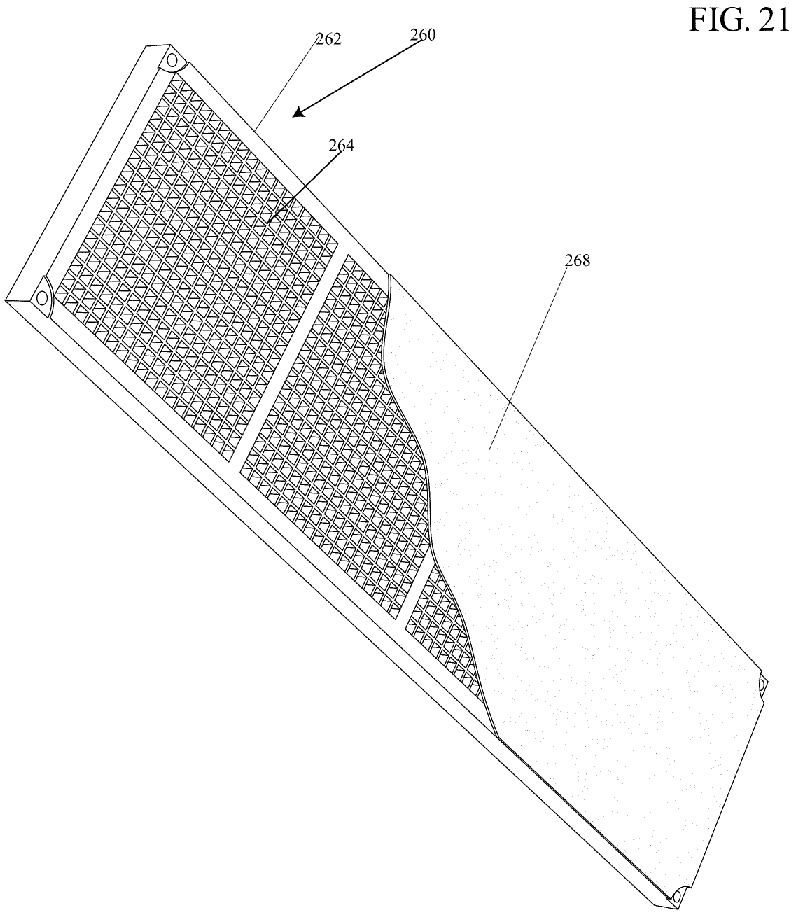

FIG. 21 is a view of another panel 260 which has an outer frame 262, a body section 264 as well as a cover 268. With this design, it forms an enclosed panel so that it is a waterproof panel. This panel 260 can be used in place of panel 10 as well.

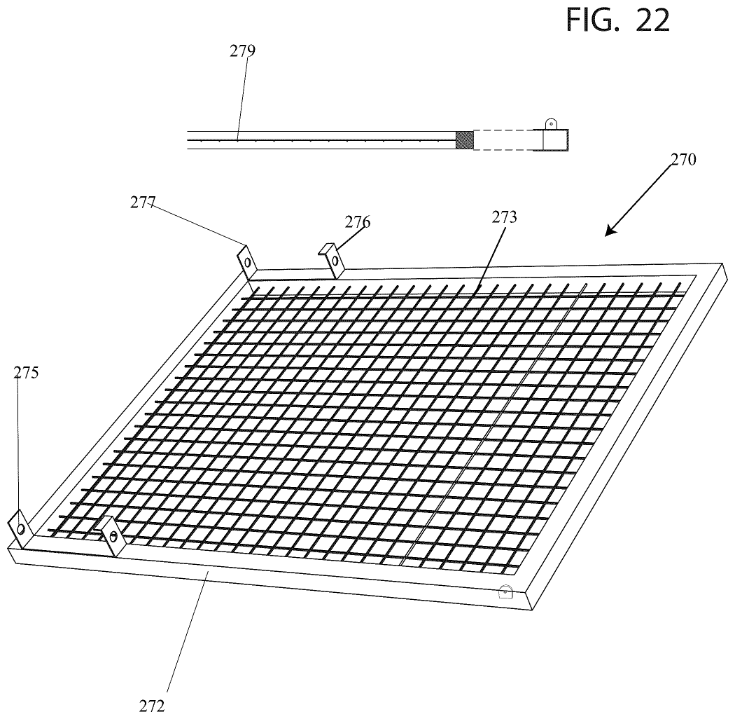

FIG. 22 is a view of another panel. This panel 270 includes a body section 273, an outer bracket 275 as well as another bracket 275 having arms 277 and 276. This panel 270 is similar to panel 62 as shown in FIG. 11 and can be used interchangeably with panel 62 as well. As shown in there is adjusting arm 279 which is similar to arm 320 as well.

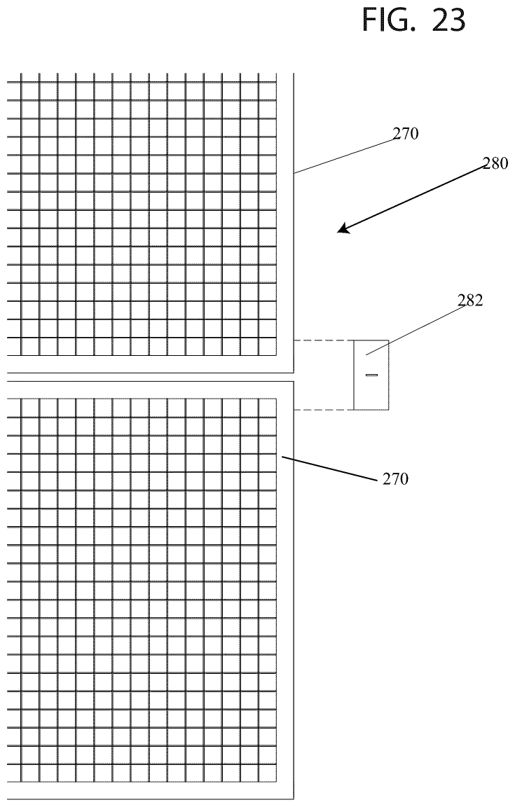

FIG. 23 is a view of another series of panels 280 which includes first and second panels 270a and 270b. There is a coupling 282 which [ins] is configured to couple the frames together so that they form a single continuous frame.

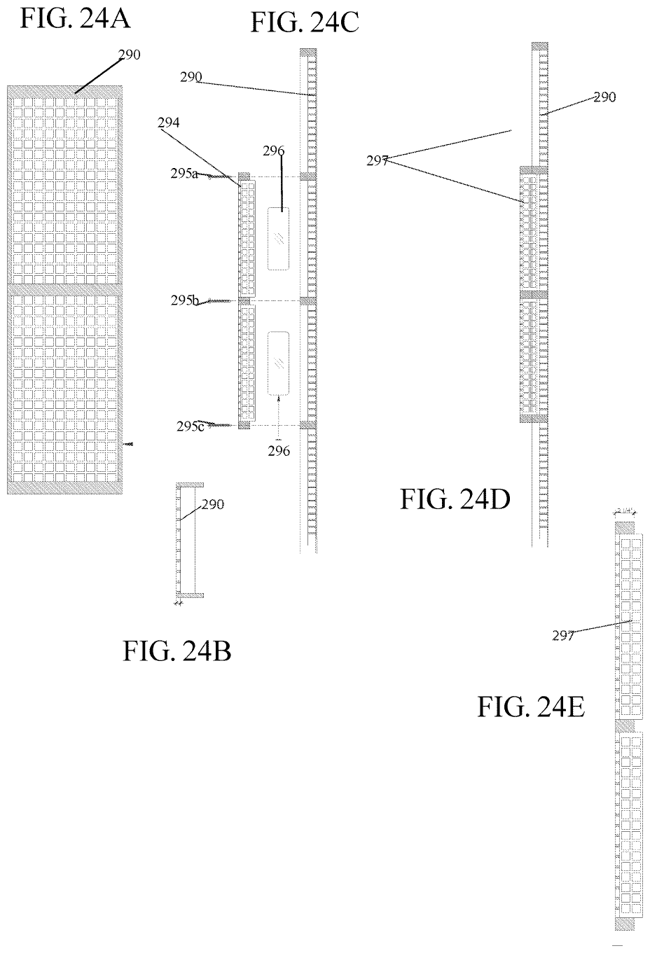

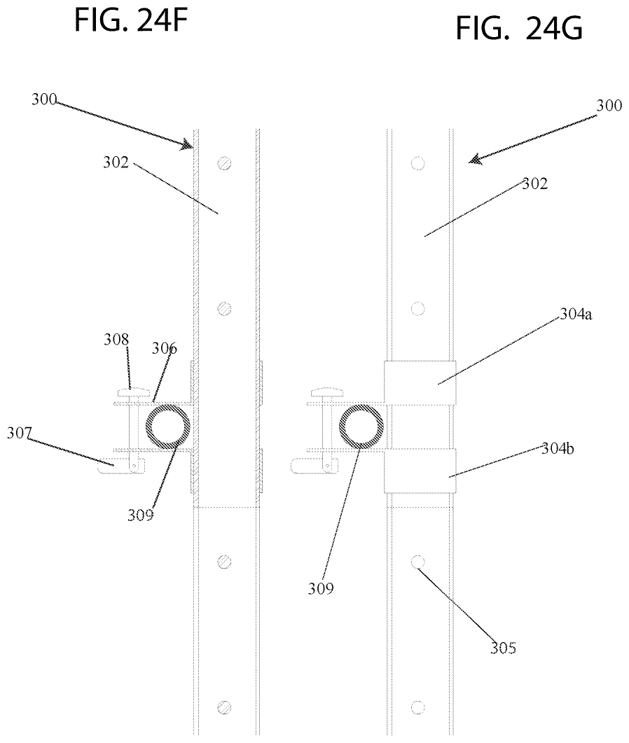

FIGS. 24C-24E are similar to FIGS. 2A-2D in that lights 296 are positioned to be inside of panel 294 secured by screws 295a, 295b, 295c FIG. 24D shows panel 297 secured to panel 290 and FIG. 24E shows the end view of these panels.

FIG. 24F is a view of a frame which includes beams 300, comprising a first beam 302, a bracket 306 coupled to the beam 302, and a locking pin 308 having a lock 307. There is a channel 309 which is configured to allow for the passage of electrical wiring, water, or pneumatic power to flow therethrough.

FIG. 24G is a view of another frame which shows the back end of the frame comprising beam 302, a bracket 306 is shown having couplings 304a and 304b as well as channel 309 shown therein.

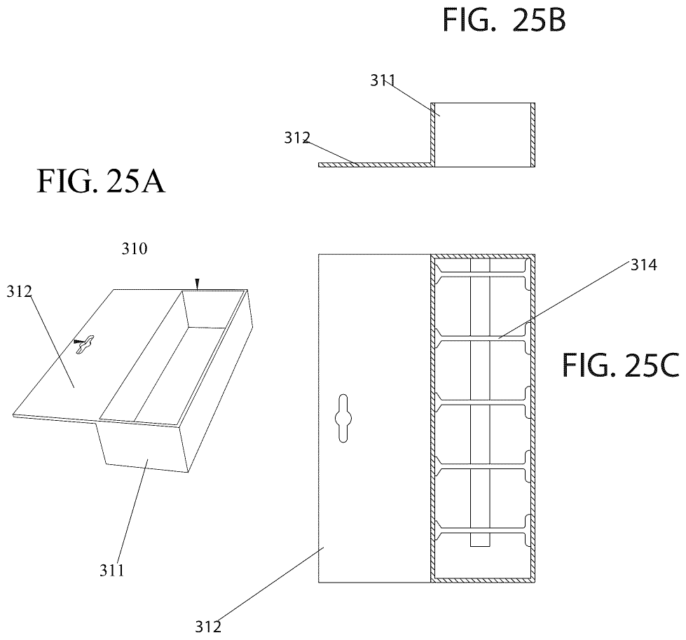

FIG. 25A is a view of a box such as a lock box 310. The box 310 includes a body section 311 and a cover 312 a side view of this box is also show in FIG. 25B. FIG. 25C is a view of the box having body 311, a cover 312 and dividers 315. The dividers are used to divide compartments in the box. There is also a channel 316 extending along the longitudinal axis of the box.

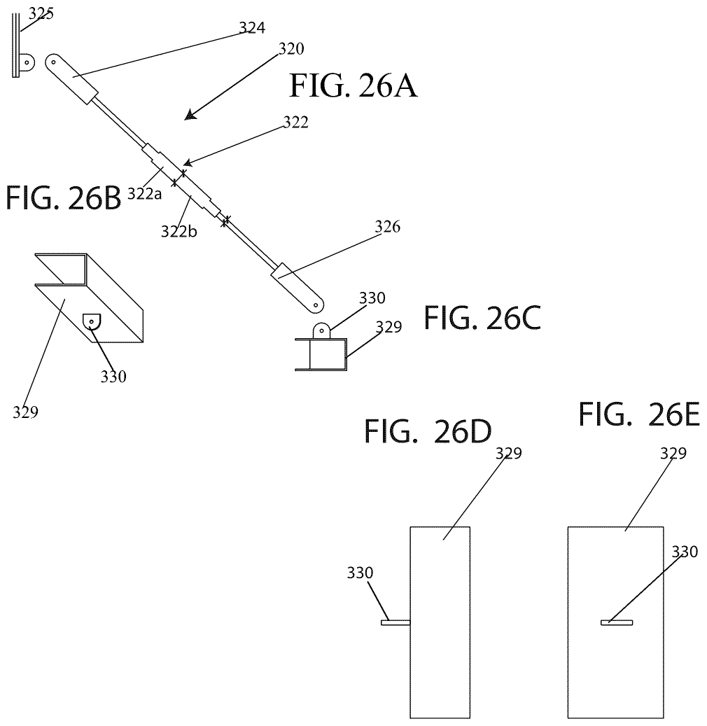

FIG. 26A is a view of a brace, with this brace 320 there are bracket ends 324 and 326 as well as a coupling bracket 329 having a flange 330. This brace 320 is configured to be coupled at one end to the panel 62 and at another end to the panel 10 to set panel 62 at a pre-set angle and height. There is a center portion 322 which is configured to be rotated with section 322a being rotated vs. section 322b to either extend the length of brace 320 or shorten brace 320 to set the angle of panel 62 vs. plank or panel 10 when panel 62 is coupled to a frame such as frame 400.

FIG. 26B is a view of a bracket 329 having a flange 330 extending out therefrom.

FIG. 26C is a side view of a bracket 329 having flange 330. FIG. 26D is a side view of the bracket 329 having flange 330. FIG. 26E is a top view of the bracket 329 having flange 330.

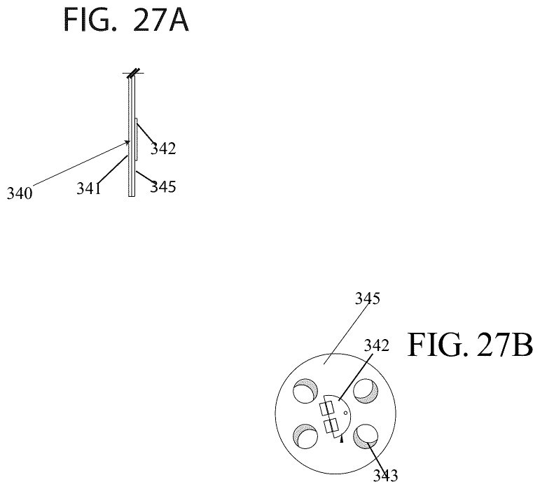

FIG. 27A is a side view of a lock 340 having a first plate 341, and a second plate 345. There is a flange 342 extending out from plate 345. This lock 340 is substantially circular with a plurality of holes 343. The lock 340 is configured so that when the second plate 345 is twisted against first plate 341 it locks the lock in place. As shown in FIG. 27B there are a series of holes 343 shown extending through both plates 341 and 345. This lock 340 is configured to lock through bolts such as bolts 33 on the H-shaped bracket 32 to lock at least two H-shaped brackets together which are adjacent to each other. The holes 343 are configured to receive bolts 33 extending through holes 343 to allow lock 340 to lock at least two separate brackets 32 together.

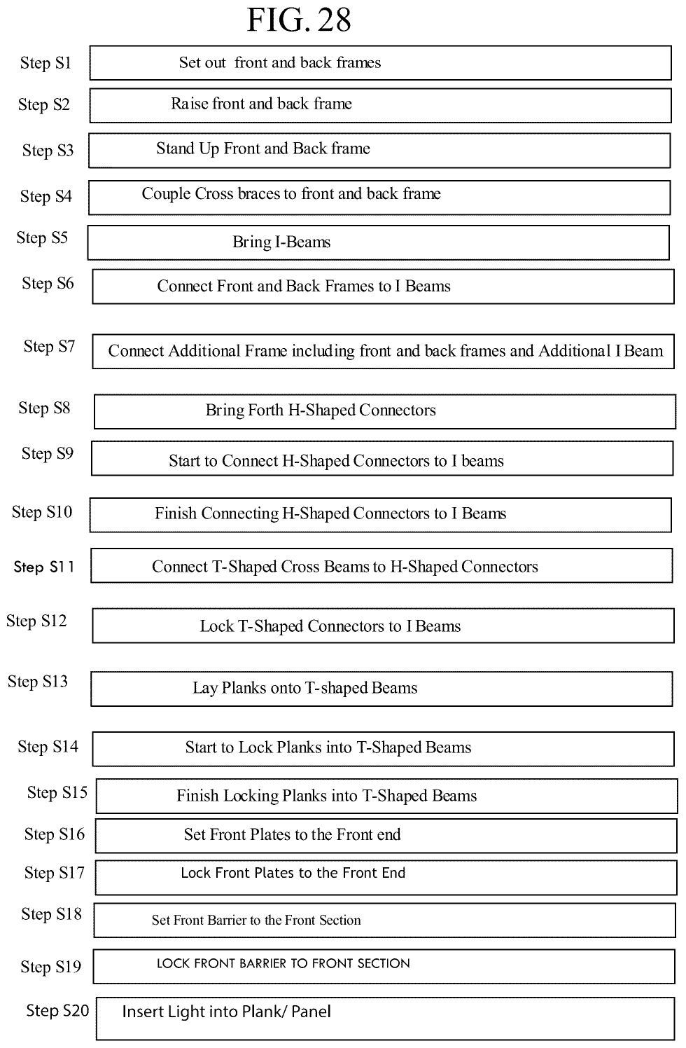

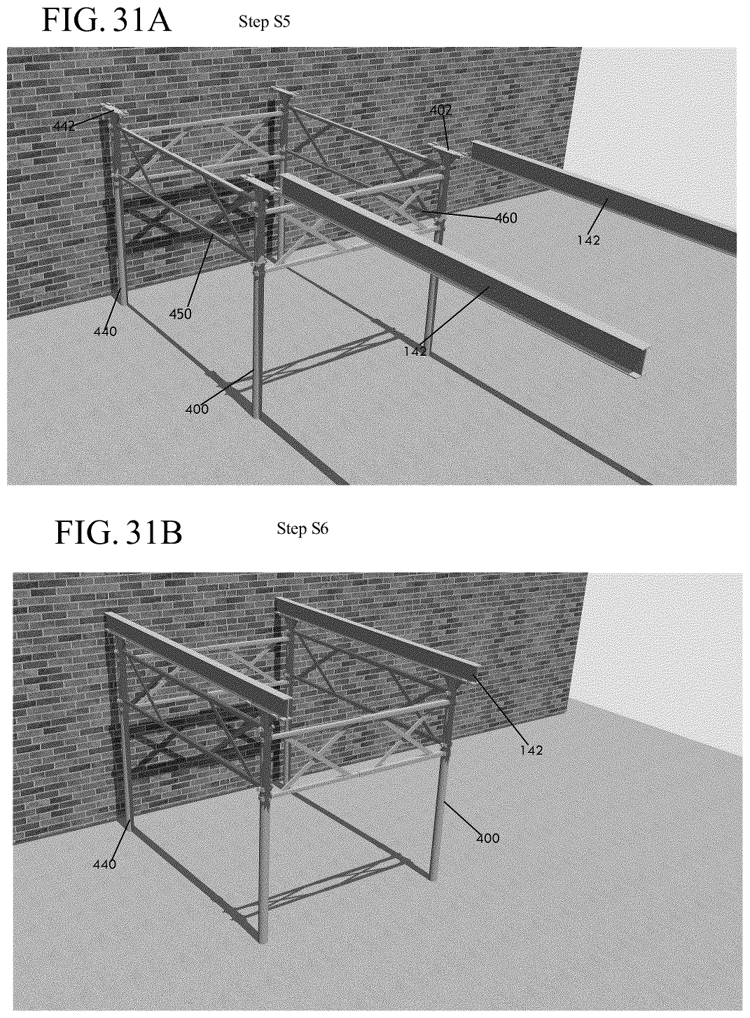

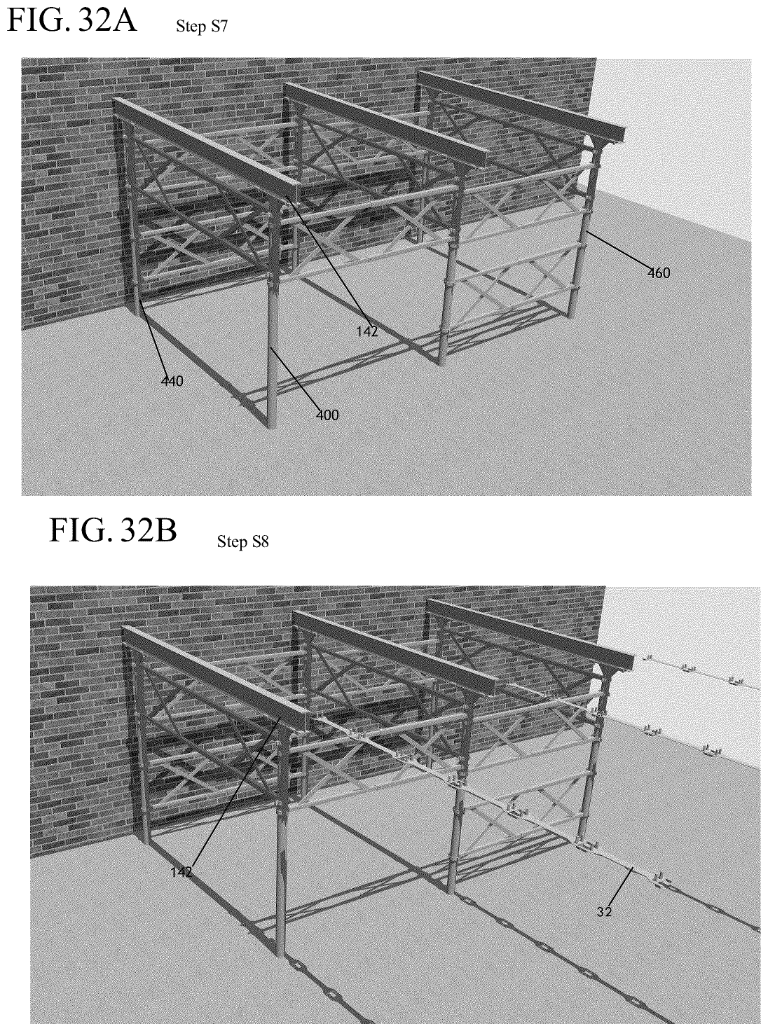

FIG. 28 is a flow chart for the process for assembling a sidewalk shed. For example, the process starts in step S1 wherein as shown in FIG. 29A a front frame 400 and a back frame 440 are set out for assembly. Next, in step S2 as shown in FIG. 29B, the front frame 400 and the back frame 440 are raised up. The front and back frames 400 and 440 each have top plates 402 and 442. Next, in step S3 as shown in FIG. 30A the front frame 400 and the back frame 440 are raised to their upright positions. Each of these frames 400 and 440 include parallel spaced columns 403 and 405 as well as a cross beam 407. Next, in step S4 as shown in FIG. 30B, the cross braces 450 are coupled to both the front frame 400 and the back frame 440. Next, in step S5, as shown in FIG. 31A the I beams 142 are brought forth, and in step S6 as shown in FIG. 31B the I-beams are coupled to the top plates 402 and 442 via fasteners. Next, in step S7 as shown in FIG. 32A the additional frame 460 is coupled to both the front and back frames 400 and 440.

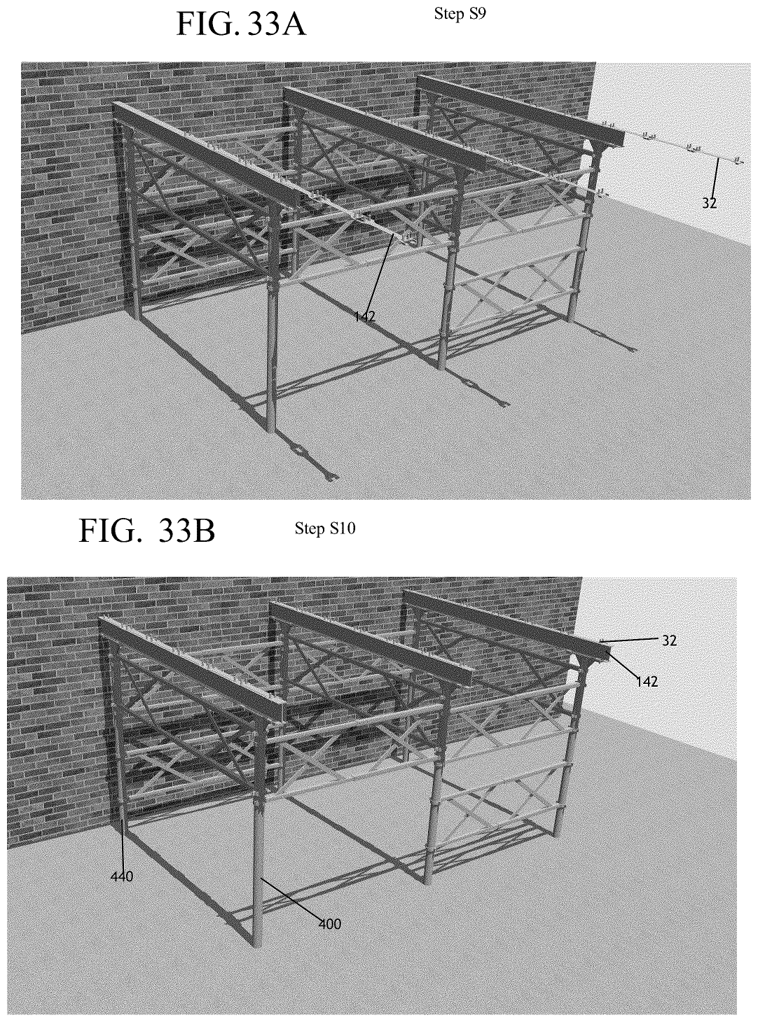

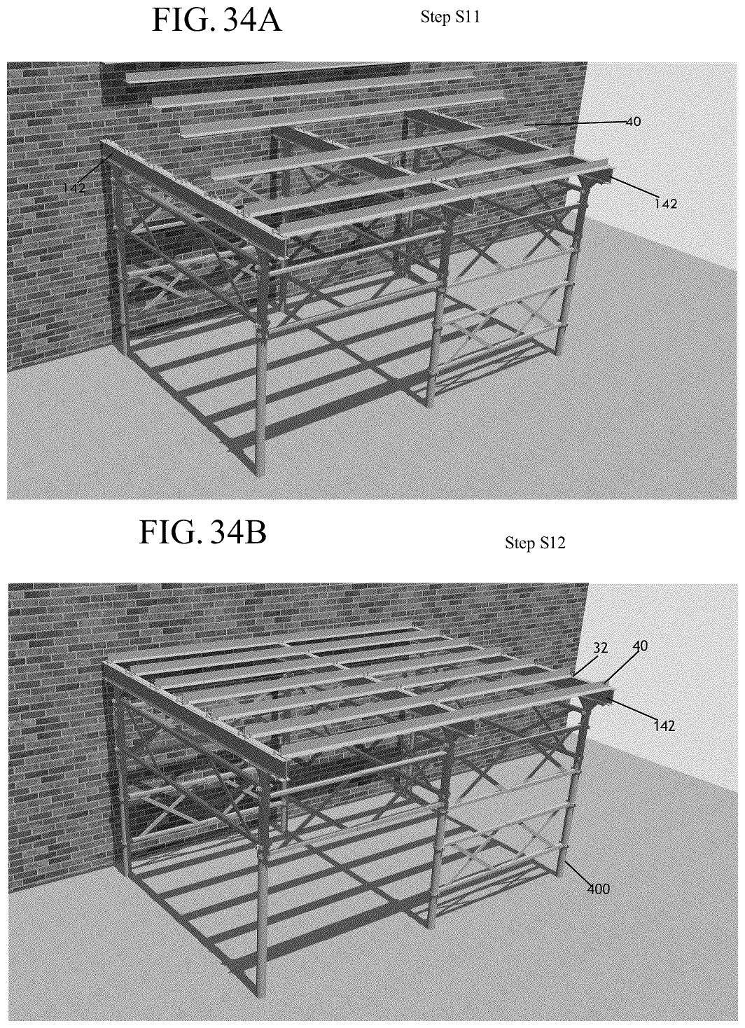

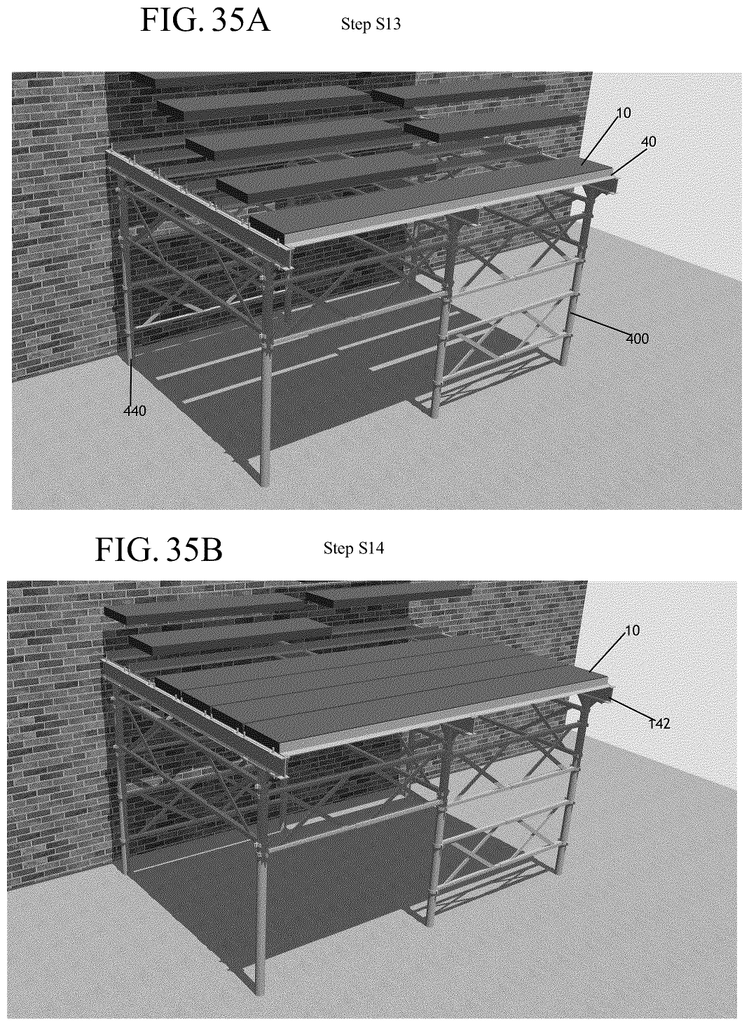

Next, in step S8 as shown in FIG. 32B connecting H-brackets 32 are coupled to the top of I-beams 142. These H-brackets 32 are coupled through a clamp 35 shown in FIG. 4. The further fastening of these H-brackets 32 are accomplished in steps S9 and S10 shown in FIGS. 33A and 33B. Next, in step S11 as shown in FIG. 34A the T-shaped beams 40 are placed on the I-beams and then in step S12 (See FIG. 34B) these T-shaped beams 40 are coupled to the top of the I-beams 142 via the H-shaped brackets 32. Next, in step S13 in FIG. 35A the planks or panel 10 are placed on the tops of the I-beams 142 between the T-shaped beams 40. Next, in step S14 in FIG. 35B the planks or panel 10 are further placed on top of I-beams 142. Next, in step S15 as shown in FIG. 36A these planks or panel 10 are locked to T-shaped beam 40 on top of I-beams 142. Next, in step S16 (see FIG. 36B) the front plates 500 are coupled to frame 400 adjacent to T-shaped beam 40. Next, in step S17 as shown in FIG. 37A these plates 500 are locked to frame 400. Next, in step S18 as shown in FIG. 37B barriers 62 are coupled to plates 500 and to frames 400 via brackets 64 and 66 (See FIG. 8) and are then adjusted to be flush with frame 400 via support rod 320 shown in FIG. 26A. Support rod 320 is configured to be adjustable in length with one end coupled to the plank or panel 10 on top of the I-beams 142 as well as to the other end to barrier 62. When the length of rod 320 is adjusted, it adjusts the angle at which barrier 62 intersects with frame 400, wherein this rod 320 can then create a barrier to frame intersection wherein the barrier 62 is substantially vertically extending (See step S19 and FIG. 38). Next, in step 20 the user can insert a light into the panel (see FIGS. 2A, 2B and 2C for example). Since power is already provided via a power line such as power like 101 to the shed structure, and in particular to the panels 10, this allows for the easy connecting of a light disposed in a panel. The panel then has a first panel section 24 coupled to a second panel section 22 via bolts 26 to encase lights 18 therein.

Thus, there is created and easily assembled sidewalk shed which is made with particular connectors and modular components so that this type of shed can be easily coupled together and then assembled rapidly. This type of design allows for lighting, electrical connections, electrical conduits as well as optional water conduits as well.

Accordingly, while at least one embodiment of the present invention have been shown and described, it is to be understood that many changes and modifications may be made thereunto without departing from the spirit and scope of the invention as defined in the appended claims.

What is claimed is:

1. A modular shed design comprising:
at least one frame (400, 440);
at least one panel (10) coupled to said at least one frame (400, 440);
at least one connector (32) coupled to the frame, said at least one connector for coupling said at least one panel to said at least one frame;
at least one light (18) said at least one light being disposed in said at least one panel (10); and
at least one electrical conduit (101) disposed in said at least one frame, said at least one electrical conduit configured to provide power to said at least one light (18).

2. The modular shed design as in claim 1, further comprising at least one water conduit 103 disposed in said frame.

3. The modular shed design as in claim 1, further comprising at least one pneumatic conduit (107) disposed in said frame.

4. The modular shed design as in claim 1, wherein said panel comprises a grate section (12) and a frame section (16).

5. The modular shed design as in claim 1, wherein said light (18) is disposed between at least two panels.

6. The modular shed design as in claim 1, wherein said at least one connector (18) is an H-shaped connector.

7. The modular shed design as in claim 6, wherein at least one T shaped beam (40) is configured to be coupled to said H-shaped connector.

8. The modular shed design as in claim 7, wherein said panel (10) is configured to be set adjacent to said at least one T-shaped beam (40).

9. The modular shed as in claim 1, further comprising an I-beam 142, wherein said at least one frame (400, 440) comprises at least one additional frame (440), wherein said at least one frame 400 is spaced apart from said at least one additional frame (440) and wherein said at least one frame (400) is coupled to said at least one additional frame (440) via an I-beam (142).

10. The modular shed as in claim 9, further comprising at least one lock (340), wherein said lock 340 is configured to lock at least two connectors (32) together.

11. The modular shed as in claim 10, wherein said lock (340) is configured to be coupled to at least one bolt (33) on said connector (32).

12. The modular shed as in claim 1, wherein at least one plank (250) can be used in place of said at least one panel (10).

13. A process for assembling a modular shed comprising the steps of:
a) spacing at least two frames (400, 440) apart from each other;
b) coupling said spaced apart frames (400, 440) together via at least one beam (142);
c) connecting at least one connector (32) to at least one beam (142);
d) connecting at least one panel (10) to said at least one frame (400);
e) connecting at least one light (18) to said at least one panel (10) such that said at least line light is disposed in said panel (10);
f) illuminating said at least one light inside of said at least one panel (10).

14. The process as in claim 13, further comprising the step of coupling at least one additional panel (62) to said frame (400).

15. The process as in claim 14, further comprising adjusting at least one angle for said at least one additional panel (62) being coupled to said frame (400).

16. The process as in claim 15, wherein said at least one additional panel (62) is a front panel positioned in a front portion of the shed.
